(19) United States
(12) Patent Application Publication
(10) Pub. No.: US 2014/0207032 A1
(43) Pub. Date: Jul. 24, 2014

(54) Pulsation System and Method

(71) Applicants: FNU DEMATIO, Singapore (SG); Kik Heong Gee, Singapore (SG)

(72) Inventors: FNU DEMATIO, Singapore (SG); Kik Heong Gee, Singapore (SG)

(21) Appl. No.: 13/745,674

(22) Filed: Jan. 18, 2013

(51) Int. Cl. A61H 19/00; H04B 7/26

(52) U.S. Cl. CPC A61H 19/00; H04B 7/26
USPC 601/46; 455/68

(57) ABSTRACT

A pulsation system and method includes a pulsation device that generates pulsation patterns and ancillary therapeutic techniques, such as music, images, and aromatherapy. A communication device operates the pulsation device. The communication device transmits signals to the pulsation device through cable or wireless connectivity. Pulsation patterns and ancillary therapeutic techniques store in communication device data storage portion. The stored pulsation patterns and ancillary therapeutic techniques can be retrieved by the communication device and used repetitively to generate prerecorded pulsation patterns. The pulsation system coordinates the pulsation signals in chronological pattern to provide different rhythms and intensities of pulsations. The pulsation system also coordinates the playback of audio and images into a chronological pattern, forming an audiovisual story. The remote signal includes a remote user's voice.

### CROSS-REFERENCE TO RELATED APPLICATIONS

The present Utility patent application claims priority benefit of the U.S. provisional application for patent Ser. No. 61/588,196 entitled “Remote control personal massager with recording and playback functions”, filed on Jan. 19, 2012 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to pulsating devices. More particularly, one or more embodiments of the invention relate to a method and system for operating a pulsating device with varying signals from a remote area.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a massage is the manipulating of superficial and deeper layers of muscle and connective tissue using various techniques, to enhance function, aid in the healing process, decrease muscle reflex activity, inhibit motor-neuron excitability and promote relaxation and well-being.

Typically, a sex toy is an object or device that is primarily used to facilitate human sexual pleasure. Many popular sex toys are designed to resemble human genitals and may be vibrating or non-vibrating.

Typically, portable communications devices refer to hand-held or wearable devices that transmit signals to and from each other. For example, the Walkie Talkie is a device that is hand-held when in use, and wearable when not in use. Portable telephones are also carried, or worn, on a belt, or in a pocket. Portable computers are computers that can be hand-held, used on a lap, or worn in a pocket, belt, or the like, such as Personal digital assistants.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a flowchart diagram of the steps for an exemplary pulsating method for a pulsating device such as a personal massager, in accordance with an embodiment of the present invention;

FIG. 2 illustrates a detailed perspective view of an exemplary pulsation device and an exemplary communication device, in accordance with an embodiment of the present invention;

FIGS. 3A and 3B illustrate a system block diagram for an exemplary pulsation system, where FIG. 3A illustrates an exemplary communication device transmitting signals to an exemplary pulsation device, and FIG. 3B illustrates an exemplary pulsation device, in accordance with an embodiment of the present invention;

FIG. 4 illustrates a detailed perspective view of exemplary communication devices transmitting signals to an exemplary pulsation device, in accordance with an embodiment of the present invention;

FIG. 5 illustrates a front view of an exemplary pulsation pattern stored and played back, in accordance with an embodiment of the present invention;

FIG. 6 illustrates a front view of an exemplary pulsation pattern programmed into an exemplary pulsation system, in accordance with an embodiment of the present invention;

FIG. 7 illustrates a flowchart diagram of the steps for playing back a pulsation pattern into an exemplary pulsating method, in accordance with an embodiment of the present invention;

FIGS. 8A and 8B illustrate detailed perspective views of an exemplary remote pulsation system, where FIG. 8A illustrates an exemplary pulsation device with two exemplary communication devices, and FIG. 8B illustrates a remote user communication device communicating with a user communication device to actuate an exemplary pulsation device, in accordance with an embodiment of the present invention;

FIGS. 9A and 9B illustrate a system block diagram for an exemplary remote pulsation system, where FIG. 9A illustrates an exemplary remote user communication device transmitting signals to an exemplary user communication device and an exemplary pulsation device, and FIG. 9B illustrates an exemplary remote pulsation device, in accordance with an embodiment of the present invention;

FIG. 10 illustrates a flowchart diagram of the steps for an exemplary remote pulsating method, in accordance with an embodiment of the present invention;

FIG. 11 illustrates a typical computer system that, when appropriately configured or designed, can serve as an exemplary method for tracking, in accordance with an embodiment of the present invention; and

FIG. 12 illustrates a block diagram depicting a conventional client/server communication system, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, infra red, radio frequency, Wi-Fi.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 1102.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

The present invention will now be described in detail with reference to embodiments thereof as illustrated in the accompanying drawings.

There are various types of systems and methods for generating pulsations in response to signals. The pulsation system and method may include a pulsation device that generates pulsation patterns and ancillary therapeutic techniques in response to varying and preprogrammed signals. The pulsation device may include, without limitation, a sex toy, a massage stick, a back massager, a foot massager, and a massage chair. The pulsation pattern may include, without limitation, choreographed, mapped, synchronized, and freeform application of pulsation, strokes, vibration, pressure application, and massage techniques. The intensity and rhythm of the pulsation patterns may be dictated by the preselected conditions of a user, or a preprogrammed audiovisual story. In some embodiments, the pulsation system and method may be enhanced through coordination with ancillary therapeutic techniques, including, without limitation, music, silence, ambient noise reduction, 360 degree site cancellation, aroma therapy, images, photos, animations, videos, voices, sound effects and music programmed or played together with custom pulsations. In some embodiments, a communication device may operate the pulsation device. The communication device may include, without limitation, smartphones, mobile phones, tablets, personal computers, laptops, mini computer, set top box, smart TV and personal digital assistants. The communication device may transmit signals to the pulsation device through cable or wireless connectivity, including, without limitation, Bluetooth™, Bluetooth Low Energy, Wi-Fi, Near Field Communication, and radio frequency. In some embodiments, the pulsation patterns and ancillary therapeutic techniques generated by the pulsation device may be stored in a data storage portion. The stored pulsation patterns and ancillary therapeutic techniques may then be retrieved by the communication device and used repetitively by the pulsation device to generate prerecorded pulsation patterns. In some embodiments, the pulsation pattern generated by the pulsation device may be synchronized with a stored audio signal and/or image. In some embodiments, the pulsation device may control the pulsations with various functions, including, without limitation, on and off signal, strength signal, and signal duration. In some embodiments, the pulsation system and method may coordinate the audio signals and images into a chronological pattern, forming an audiovisual story. The pulsation system and method may utilize time or sequence to synchronize the pulsation patterns with the audiovisual story. In this manner, the pulsation device may repetitively provide the same pulsation pattern and ancillary therapeutic technique.

In one embodiment of the present invention, the pulsation pattern may generate pulse patterns in response to remote signals from a remote user. The pulsation pattern may synchronize with the remote signal and/or image to provide different rhythms and intensities of pulsations. The remote signal and/or image may include, without limitation, a voice, music, and an image. For example, without limitation, a remote user may utilize a remote communication device to transmit the remote signal and/or image to a user communication device. The user communication device may then actuate the massage device to generate pulsations that synchronize with the remote signal and/or image. In this manner, a remote user may vary voice inflection, intensity, rhythm, pitch, volume, waveform, and spectrum to control the pulsation device for a user. Those skilled in the art, in light of the present teachings, will recognize that the remote signal may be designed to form an audiovisual story, originating from the remote communication device. In one embodiment, the audiovisual story may be shared by a plurality of users and downloaded from a remote data storage portion.

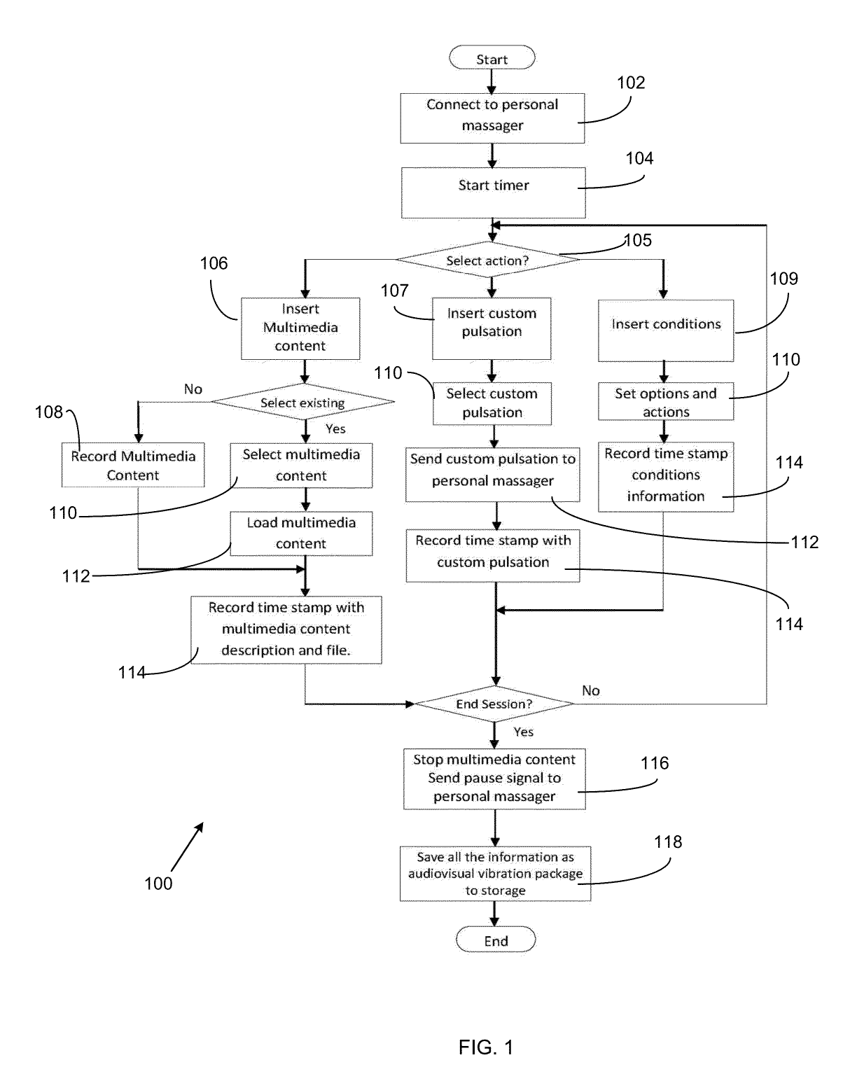

FIG. 1 illustrates a flowchart diagram of the steps for an exemplary pulsating method for a pulsating device such as a personal massager, in accordance with an embodiment of the present invention. In the present invention, a pulsation method 100 may provide pulsation patterns and ancillary therapeutic techniques that synchronize to a stored audio signals and images. A communication device may operate a pulsating device, whereby the pulsating device may generate pulsation patterns. Those skilled in the art, in light of the present teachings, will recognize that the pulsation patterns may be efficacious in treating the body by rubbing, kneading, and patting to stimulate circulation, increase suppleness, and relieve tension. In some embodiments, the intensity and rhythm of the pulsation patterns may be dictated by the preselected conditions of a user, or a preprogrammed audiovisual story. The pulsation device may include, without limitation, a sexual toy, a sexual vibrating device, a massage stick, a foot massager, a back massager, and a massage chair. The communication device may be disposed to operate either in proximity or remotely from the pulsation device and the user. The pulsation method may include an initial Step 102 of linking a pulsation device with a communication device. The linkage may occur through cable or wireless connectivity, including, without limitation, Bluetooth™, Bluetooth Low Energy, Wi-Fi, Near Field Communication, and radio frequency. A next Step 104 may include initiating a timer to regulate the length of time that the pulsation device may provide pulsation patterns. A Step 107 may include the insert of a custom pulsation pattern which corresponds to a desired pre-programmed vibration pattern. By way of example, and not limitation, a custom vibration pattern could be set as first vibrate soft for 100 milliseconds, then vibrate hard for 500 milliseconds, etc., . . . , then stop. In one embodiments, the pulsation system and method may receive various user inputs, such as voice commands, text commands, and gesture commands. Each of these inputs may be translated into different custom pulsation patterns. The inputs may then be transmitted to the pulsation device.

In the present embodiment, a Step 105 may include inserting options, conditions and set various actions available in the system for each condition. By way of example, and not limitation, the actions could update the timer to a specific time. For example, without limitation, the user may show options of kind of massage the user desires, and present preprogrammed audiovisual stories, including, without limitation, “I need slow massage” and “I need fast massage”. Based on the selected option, the pulsation system and method may execute the preprogrammed option. In one embodiments, the pulsation system and method may jump to a certain time, sequence, or load a different audiovisual story.

In the present embodiment, a Step 106 may include inserting a stored audio signal and/or image into the communication device. In some other embodiments, the audio and/or image may be instead stored in the pulsation device; e.g., if the communication device was configured to include multimedia capabilities. The inserted audio signal and/or image may be choreographed to form an audiovisual story. In some other embodiments, the audiovisual story may include, without limitation, a human voice having different rhythms and intensities of voice inflection, music, video and various pulsation patterns. For example, without limitation, the user may include a woman listening to preprogrammed audio from a man introducing himself. The man may inquire what kind of massage the user desires, and present preprogrammed audiovisual stories, including, without limitation, “I need slow massage” and “I need fast massage”. Based on the selected option, the pulsation system and method may execute the preprogrammed option. In one embodiments, the pulsation system and method may jump to a certain time, sequence, or load a different audiovisual story. In yet another embodiment, the pulsation system and method may display an image of a man, who depicts a virtual lover for the woman. In yet another embodiment, the pulsation system and method may include streaming video. In some embodiments, a time stamp of the selected pulsation pattern and audio signal and/or image may be recorded and stored for future use. In yet another embodiment, the step 116 may include stopping the pulsation device and audio visual story. In yet another embodiment, a final Step 118 may include stopping, saving, and storing the pulsation pattern and audio signal and/or image in the form of the audiovisual story for future use. A remote storage portion may store the audiovisual story, whereby a plurality of users may share and download the same audiovisual story.

It should be noted that in the present embodiment that the pulsation pattern is not in any way based on any audiovisual signal or content, and is instead strictly the preprogrammed pulsation pattern described above. It is an aspect of the present invention, that when the preprogrammed pulsation pattern is played in this manner when the audio is being played at the same time, it gives the user the psychological impression that the pulsation patterns are based on the audio/visual signals when indeed they are not. It is contemplated that this effect may be similar to how the patterned moving of lips in a cartoon gives viewers the sense that the mouth is lip synching with character's speech, when it is not at all correlated. In many practical applications, this can greatly simplify system implementation complexity and save system cost, with minimal impact to user enjoyment.

Of course, if desired, some embodiments of the pulsation device may be configured to vibrate in sync with the streaming audio and/or video. In such other embodiments, the pulsation device may be fully customizable throughout the streaming video, whereby the user may watch the video from the communication device, and the pulsation device may vibrate according to the associate pulsation patterns.

In some embodiments, the audiovisual story may be shared by a plurality of users and downloaded from a remote data storage portion. The stored audio signal and/or image may include, without limitation, multimedia content, custom pulsation patterns, and preconditions.

In one embodiment of the present invention, if the stored audio signal and/or image are not available a user may then proceed to a Step 108, recording a new stored audio signal and/or image. A Step 110 may include selecting the desired audio signal and/or image. The preconditions for the pulsation pattern may also be selected in Step 110. In some embodiments, a Step 112 may include transmitting the selected pulsation pattern and audio signal and/or image from the communication device to the pulsation device. In some embodiments, the communication device may transmit signals to the pulsation device through cable or wireless connectivity, including, without limitation, Bluetooth™, Bluetooth Low Energy, Wi-Fi, Near Field Communication, and radio frequency. In some embodiments, the signals may include a custom pulsation signal for generating a preprogrammed pulsation pattern. The custom pulsation signal may include a combination one or more functions for regulating the speed and intensity of the pulsation patterns, including, without limitation, on and off signal, speed signal, and duration signal. The speed values for the pulsation device may range from 0 to 255, where 0 signifies a pause, and 255, which signify a maximum speed for pulsation patterns. The duration for the pulsation pattern may be stored in millisecond. For example, without limitation, a custom pulsation value of “200,500, 0,300” signifies that the pulsation device may utilize a motor speed at 200 for 500 milliseconds, followed by pausing for 300 milliseconds. In some embodiments, after the time and speed have completed a cycle, the pulsation device may repeat them over again. Repeating these values over and over again may generate the desired pulsation pattern. In some embodiments, a time stamp of the selected pulsation pattern and audio signal and/or image may be recorded and stored for future use in a Step 114. The pulsation pattern and audio signal and/or image may be saved as an audiovisual story and later shared by a plurality of users and downloaded from a remote data storage portion.

In one embodiment of the present invention, the pulsation system and method may utilize time or sequence to play back a stored pulsation patterns and audio signal and/or image. In some embodiments, the pulsation setting for time may include several combinations, as exemplified in Table 1 below.

TABLE 1

| Time | Actions |
|---|---|
| 00:01 | Load audio “SexyVoiceByJoe” |
| | Load image “ImageJoe1” |
| 00:30 | Load pulsation “Soft1 pattern” |
| 00:45 | Load pulsation “pause” |
| | Load image “ImageJoe4” |
| 00:50 | Load pulsation “Hard3 pattern” |
| 01:30 | Load video “VideoJoeWorkout” |

In some embodiments, the pulsation setting for sequence may include several combinations, as exemplified in Table 2 below.

TABLE 2

| | | Duration | Repetition |
|---|---|---|---|
| No | Actions | (optional) | (optional) |
| 1 | Load audio “SexyVoiceByJoe” | 00:60 | |
| | Load image “ImageJoe1” | | |
| 2 | Load pulsation “Soft1 pattern” | | 2 |
| 3 | Load pulsation “pause” | 00:10 | |
| | Load image “ImageJoe4” | | |
| 4 | Load pulsation “Hard3 pattern” | | 3 |
| 5 | Load video “VideoJoeWorkout” | | |

In some embodiments, the pulsation setting for time may include interaction between pluralities of users. Several combinations may be exemplified in Table 3 below.

TABLE 3

| Time | Actions |
|---|---|
| 00:01 | Load audio “SexyVoiceByJoe” |
| | Load image “ImageJoe1” |
| 00:30 | Pause |
| | Show question “How do you feel today?” |
| | Show options “a. Tired; b. Ok; c. Great;” |
| | Conditions: |
| | a. Jump to 00:31 |
| | b. Jump to 00:45 |
| | c. Load audiovisual vibration package |
| | “Story 2 at the beach” |
| 00:31 | Load pulsation “Soft1 pattern” |
| 00:44 | Stop |
| 00:45 | Load pulsation “Medium2 pattern” |
| 00:59 | Stop |

In one embodiment of the present invention, if the user desires to terminate the pulsation system and method, or the timer for the audiovisual story expires, a Step 116 may include stopping the pulsation pattern and audio signal and/or image. In one alternative embodiment, a pause may be utilized to stop the audiovisual story for a predetermined time interval. A final Step 118 may include saving and storing the pulsation pattern and audio signal and/or image in the form of the audiovisual story for future use. A remote storage portion may store the audiovisual story, whereby a plurality of users may share and download the same audiovisual story.

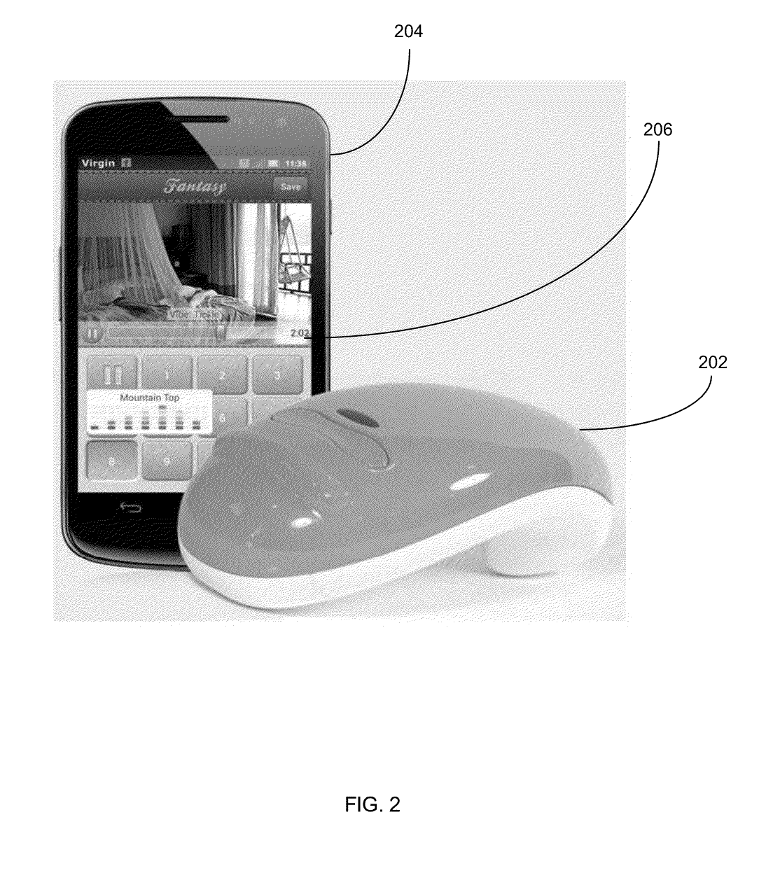

FIG. 2 illustrates a detailed perspective view of an exemplary pulsation device and an exemplary communication device, in accordance with an embodiment of the present invention. In the present invention, a pulsation device 202 may provide pulsation patterns and audio signals and/or images to a user. The pulsation device may include, without limitation, a sexual toy, a sexual vibrating device, a massage stick, a foot massager, a back massager, and a massage chair. A communication device 204 may operate the pulsating device, whereby the pulsating device generates pulsation patterns and audio signals and/or images in response to signals generated by the communication device. The communication device may be disposed to operate either in proximity or remotely from the pulsation device and the user. In some embodiments, the communication device may include a timer 206 to regulate the length of the pulsation pattern and audio signals and/or images. The communication device may include, without limitation, smartphones, mobile phones, tablets, personal computers, laptops, mini computer, set top box, and smart tv and personal digital assistants.

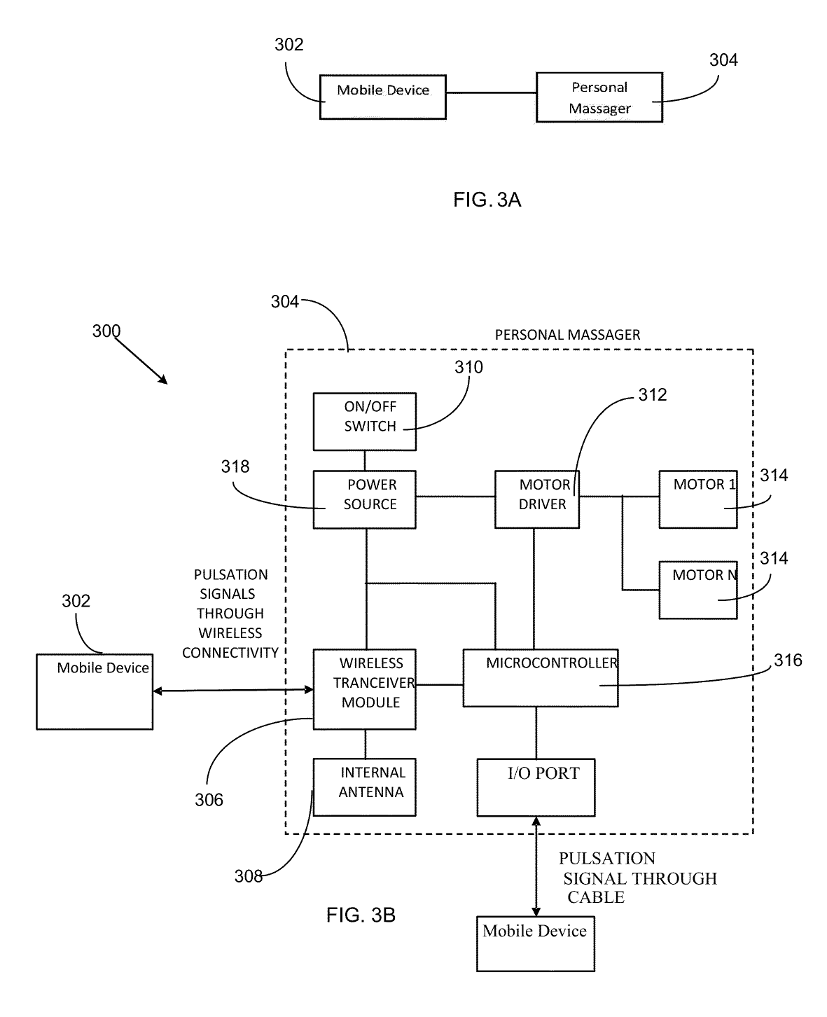

FIGS. 3A and 3B illustrate a system block diagram for an exemplary pulsation system, where FIG. 3A illustrates an exemplary communication device transmitting signals to an exemplary pulsation device, and FIG. 3B illustrates an exemplary pulsation device, in accordance with an embodiment of the present invention. In the present invention, a pulsation system 300 may include a communication device 302 linked to a pulsation device 304. The communication device may operate a pulsating device, whereby the pulsating device generates pulsation patterns and audio signals and/or images. In some embodiments, the communication device may include, without limitation, smartphone, mobile phone, tablet, laptop, personal computer, and standalone controller. In one alternative embodiment, the standalone controller may serve as an alternative for users without using smartphone, mobile phone, tablet, laptop or personal computer. The standalone controller may include, without limitation, microcontroller, input output port for cable connection, wireless transceiver module, antenna, LCD screen, touch screen, keypad, memory and power source. In some embodiments, software may be required to be installed into the standalone controller to control the massager. In this manner, the stand alone controller may transmit pulsation signals in the form of a string over to the pulsating device.

In one embodiment of the present invention, the intensity and rhythm of the pulsation patterns in the pulsation device may be dictated by the preselected conditions of a user, or a preprogrammed audiovisual story. In some embodiments, an on/off switch 310 may regulate power to the pulsation device. A microcontroller 316 may be configured to govern all the required programmed logic. A wireless transceiver module 306 may utilize various connectivity, including, without limitation, Bluetooth™, Bluetooth Low Energy, Wi-Fi, Near Field Communication, and Radio Frequency. The connectivity may establish the connection between the communication device, the pulsation device, a controller, an internal antenna 308, and an input/output port for cable connection (not shown). In some embodiments, memory for storing the audiovisual story may be accessed to actuate a motor driver 312, which may drive at least one motor 314 in the pulsation device. A voltage regulator and a power source 318 may provide the appropriate power for the pulsating device.

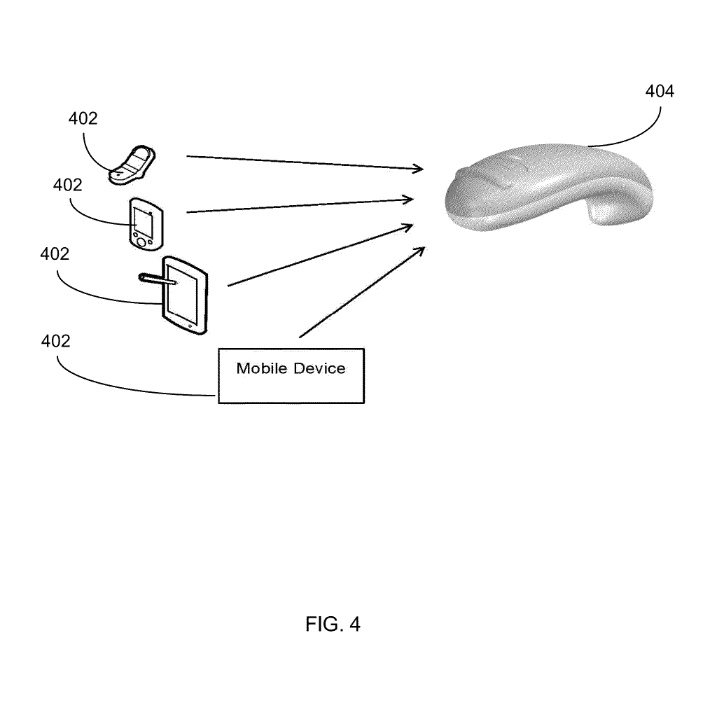

FIG. 4 illustrates a detailed perspective view of exemplary communication devices transmitting signals to an exemplary pulsation device, in accordance with an embodiment of the present invention. In the present invention, the pulsation system and method may utilize a plurality of communication devices 402 to transmit signals to the pulsation device 404. The plurality of communication devices may include, without limitation, smartphone, mobile phone, tablet, laptop, personal computer, and standalone controller. The plurality of communication devices may transmit signals to the pulsation device through cable or wireless connectivity, including, without limitation, Bluetooth™, Bluetooth Low Energy, Wi-Fi, Near Field Communication, and radio frequency.

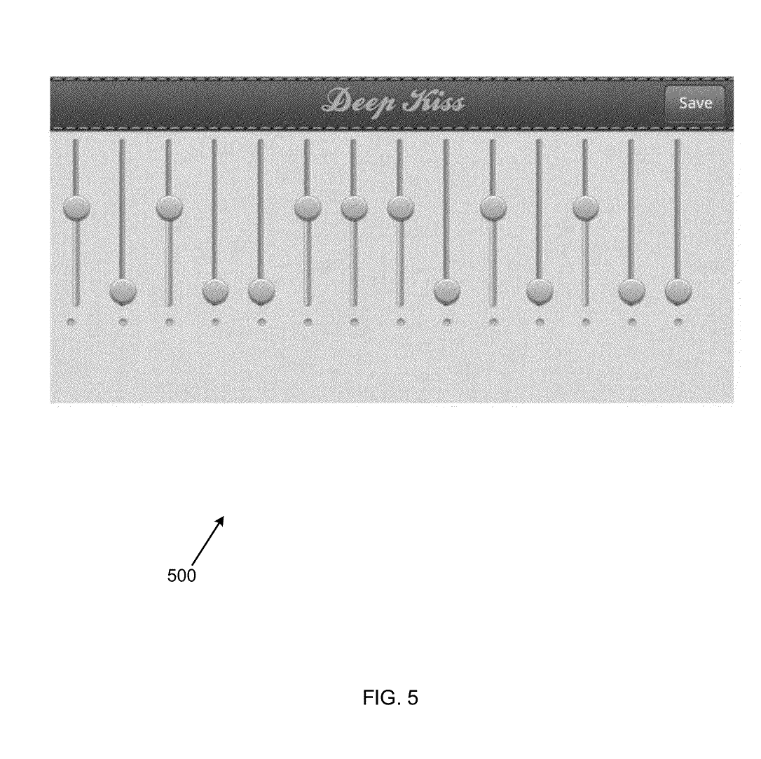

FIG. 5 illustrates a front view of an exemplary pulsation pattern stored and played back, in accordance with an embodiment of the present invention. In the present invention, the pulsation pattern generated by the pulsation device may be synchronized with a stored audio signal and/or image. A pulsation storage portion 500 may serve to save and preprogram the desired pulsation patterns and audio signals and images for future use. In some embodiments, the pulsation device may control the pulsations with various functions, including, without limitation, on and off signal, strength signal, and signal duration. In some embodiments, the pulsation system and method may coordinate the audio signals and images into a chronological pattern, forming an audiovisual story. The pulsation system and method may utilize time or sequence to synchronize the pulsation patterns with the audiovisual story. In this manner, the pulsation device may repetitively provide the same pulsation pattern and ancillary therapeutic technique. The stored audiovisual story may be downloaded and shared by a plurality of users. In one alternative embodiment, the audiovisual story may be sold for monetary profit, whereby each download of an audiovisual story requires immediate payment.

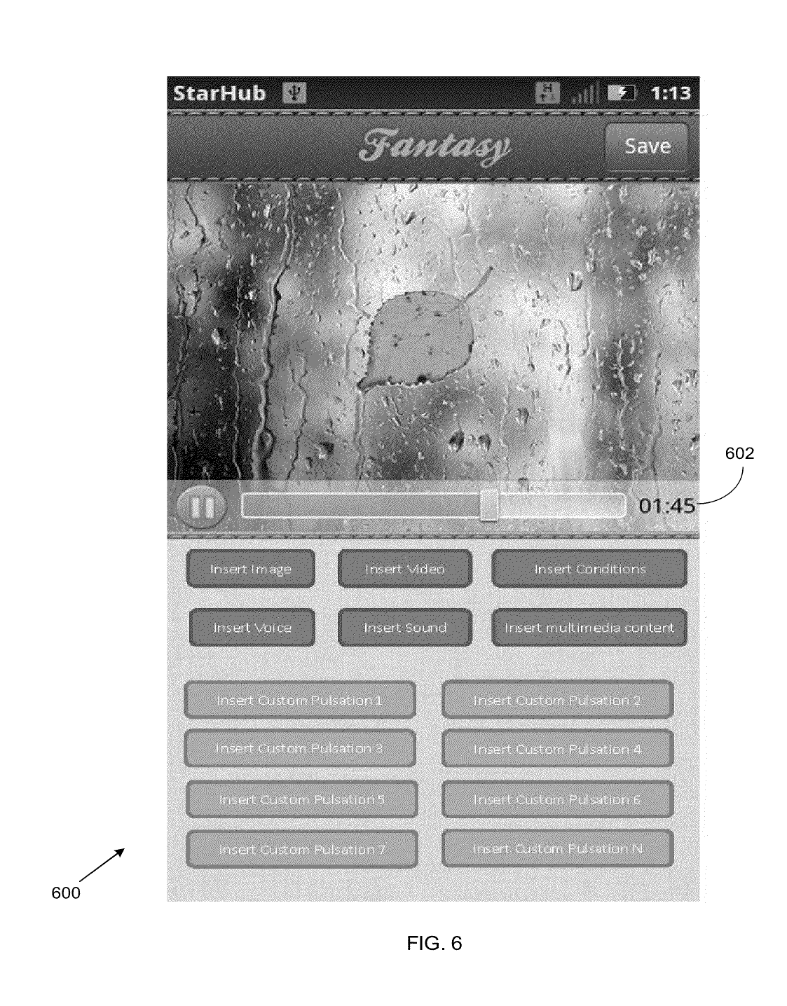

FIG. 6 illustrates a front view of an exemplary pulsation pattern programmed into an exemplary pulsation system, in accordance with an embodiment of the present invention. In the present invention, a program portion 600 may allow a user to set conditions and variables for the pulsation patterns and audio signals and images. The user may also select from a variety of preprogrammed pulsation patterns and audio signals and images that comprise an audiovisual story. The conditions and variables may include, without limitation, Insert Video, Insert Image, Insert Voice, Insert Conditions, Insert Multimedia Content, and inserting from a variety of preprogrammed audiovisual stories. In some embodiments, a timer portion 602 may regulate and display the time left for each audiovisual story. In some embodiments, the pulsation device may actuate according to a pre-recorded audiovisual story. The system may initiate a timer generate a time stamp with selected pulsation, multimedia elements, and interactive questions. Those skilled in the art, in light of the present teachings, will recognize that using the list and a timer, the system may play and load the actions such as the pulsation and multimedia content based on the time stamp. If there is an interactive question, the system may show the question and the available answers. Once the user selected the answer, the system may play the pulsation and multimedia elements based on the time stamp that linked to the answer.

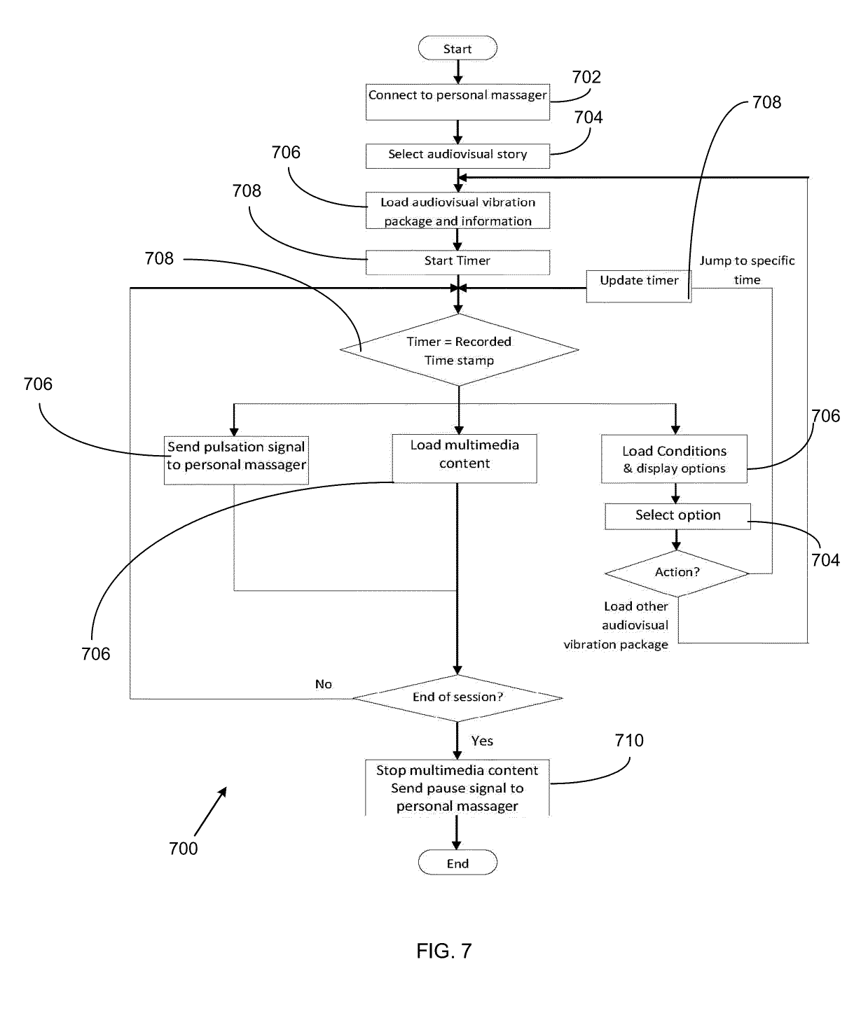

FIG. 7 illustrates a flowchart diagram of the steps for playing back a pulsation pattern into an exemplary pulsating method, in accordance with an embodiment of the present invention. In the present embodiment, a playing back pulsating method 700 may allow a user to select from a variety of preprogrammed pulsation patterns and audio signals and images that comprise an audiovisual story. In one embodiment, the programmable pulsation method may include an initial Step 702 of linking a pulsation device with a communication device. The linkage may occur through cable or wireless connectivity, including, without limitation, Bluetooth™, Bluetooth Low Energy, Wi-Fi, Near Field Communication, and radio frequency. Next, a Step 704 may include selecting a desired audiovisual story. The options may display on a communication device. A Step 706 may include the communication device loading the audiovisual story. The communication device may also transmit pulsating pattern signals to the pulsating device. In one alternative embodiment, a remote communication device may transmit the pulsating pattern signals to the pulsating device. In another embodiment, the pulsating system load preprogrammed conditions and display options. Based on the selected option, the pulsation system and method may execute the preprogrammed option. In one embodiments, the pulsation system and method may jump to a certain time, sequence, or load a different audiovisual story. In some embodiments, the communication device may transmit signals to the pulsation device through cable or wireless connectivity, including, without limitation, Bluetooth™, Bluetooth Low Energy, Wi-Fi, Near Field Communication, and radio frequency. A next Step 708 may include initiating and updating a timer portion to regulate the length of time that the pulsation device may provide pulsation patterns. The user may manipulate the timer portion to jump to specific time in order to rewind or fast forward the audiovisual story. In some embodiments, a time stamp of the selected pulsation pattern and audio signal and/or image may be recorded and stored for future use. In one embodiment, a final Step 710 may include stopping the pulsation device and audiovisual story.

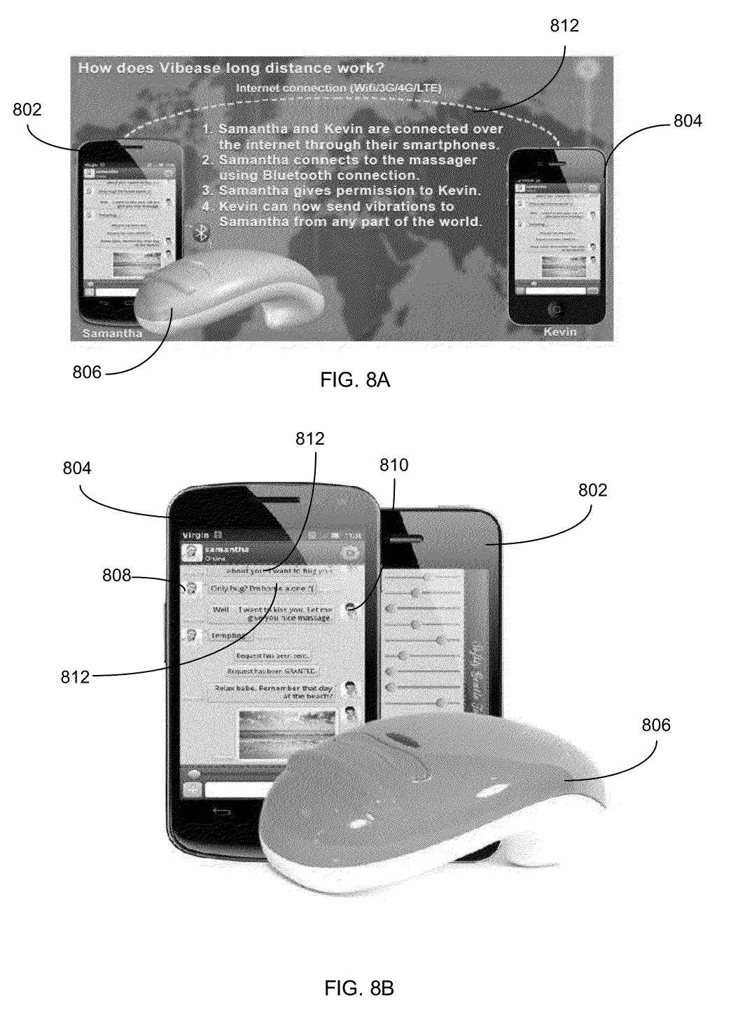

FIGS. 8A and 8B illustrate detailed perspective views of an exemplary remote pulsation system, where FIG. 8A illustrates an exemplary pulsation device with two exemplary communication devices, and FIG. 8B illustrates a remote user communication device communicating with a user communication device to actuate an exemplary pulsation device, in accordance with an embodiment of the present invention. In the present invention, a remote user 810 may control pulsation patterns of a pulsation device 806 for a user 808. The pulsation system may allow the remote user and the user to utilize a user communication device 802 and a remote communication device 804 to communicate with each other for operating the pulsation device. The remote communication device may generate a remote signal 812, including, without limitation, a pulsation pattern that provides different rhythms and intensities of pulsations. The remote signal and/or image may include, without limitation, a voice, music, and an image. In one embodiment, a remote user may utilize a remote communication device to transmit the remote signal and/or image to a user communication device. The user communication device may then actuate the massage device to generate pulsations. In the present embodiment, the pulsations patterns are preprogrammed and not necessarily related to any audio and/or visual signals/content. In some other embodiments, however, it may be desired that the pulsations patterns be, at least to some degree, modulated by or synchronize with the remote signal and/or image. In such other embodiments, a remote user may vary voice inflection, intensity, rhythm, pitch, volume, waveform, and spectrum to control the pulsation device for a user. For example, without limitation, a male may change the inflection or grammatical style while speaking to a female on their respective communication devices. The pulsation system may interpret the voice inflection and intensity of the male with voice recognition software and apply the appropriate pulsation pattern to the pulsation device used by the female.

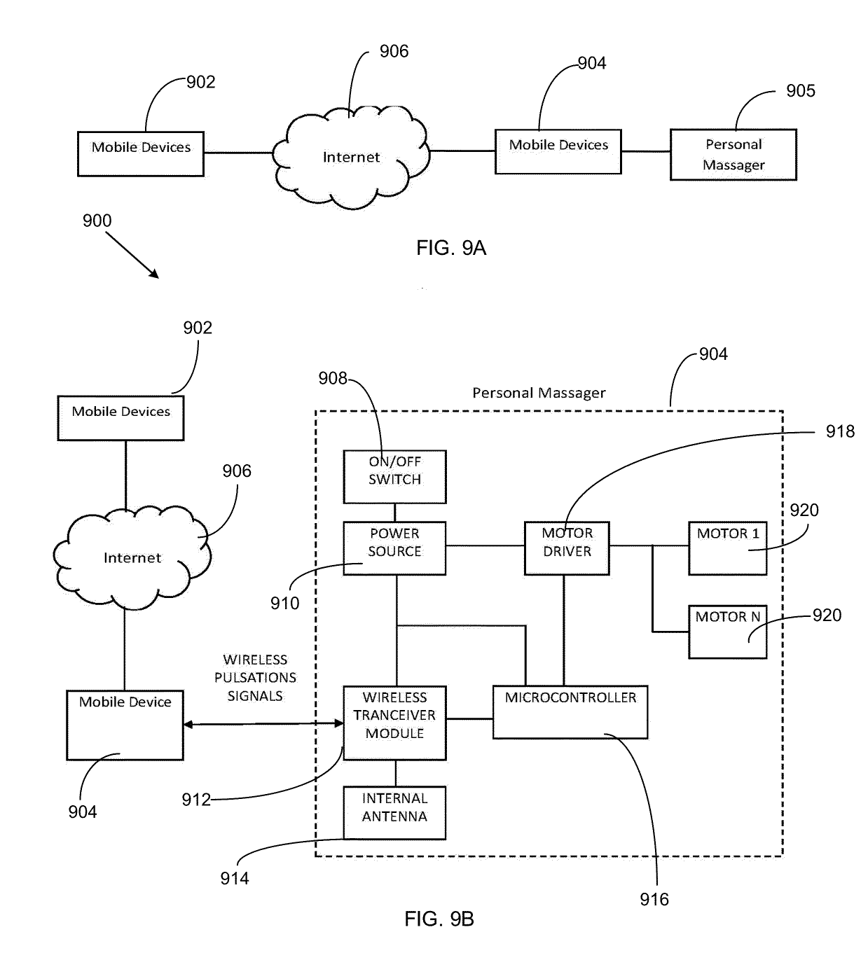

FIGS. 9A and 9B illustrate a system block diagram for an exemplary remote pulsation system, where FIG. 9A illustrates an exemplary remote user communication device transmitting signals to an exemplary user communication device and an exemplary pulsation device, and FIG. 9B illustrates an exemplary remote pulsation device, in accordance with an embodiment of the present invention. In the present invention, a remote pulsation system 900 may include a remote communication device 902 and a user communication device 904 linked to a pulsation device 905 through an internet 906. However, in other embodiments, each communication device may link through other means, including, without limitation, a cloud, a network, and a remote server. In some embodiments, the remote communication device may transmit signals to the user communication device to operate the pulsating device, whereby the pulsating device generates pulsation patterns. In some embodiments, each communication device may include, without limitation, smartphone, mobile phone, tablet, laptop, personal computer, and standalone controller. In one alternative embodiment, the standalone controller may serve as an alternative for users without using smartphone, mobile phone, tablet, laptop or personal computer. The standalone controller may include, without limitation, microcontroller, input output port for cable connection, wireless transceiver module, antenna, LCD screen, touch screen, keypad, memory and power source. In some embodiments, software may be required to be installed into the standalone controller to control the massager. In this manner, the stand alone controller may transmit pulsation signals in the form of a string over to the pulsating device.

In one embodiment of the present invention, the intensity and rhythm of the pulsation patterns in the pulsation device may be dictated by the preselected conditions of a user, or a preprogrammed audiovisual story. In some embodiments, an on/off switch 908 may regulate power to the pulsation device. A microcontroller 916 may be configured to govern all the required programmed logic. A wireless transceiver module 912 may utilize various connectivity, including, without limitation, Bluetooth™, Bluetooth Low Energy, Wi-Fi, Near Field Communication, and Radio Frequency. The connectivity may establish the connection between the communication device, the pulsation device, a controller, an internal antenna 914, and an input/output port for cable connection. In some embodiments, memory for storing the audiovisual story may be accessed to actuate a motor driver 918 which may drive at least one motor 920 in the pulsation device. A voltage regulator and a power source 910 may provide the appropriate power for the pulsating device.

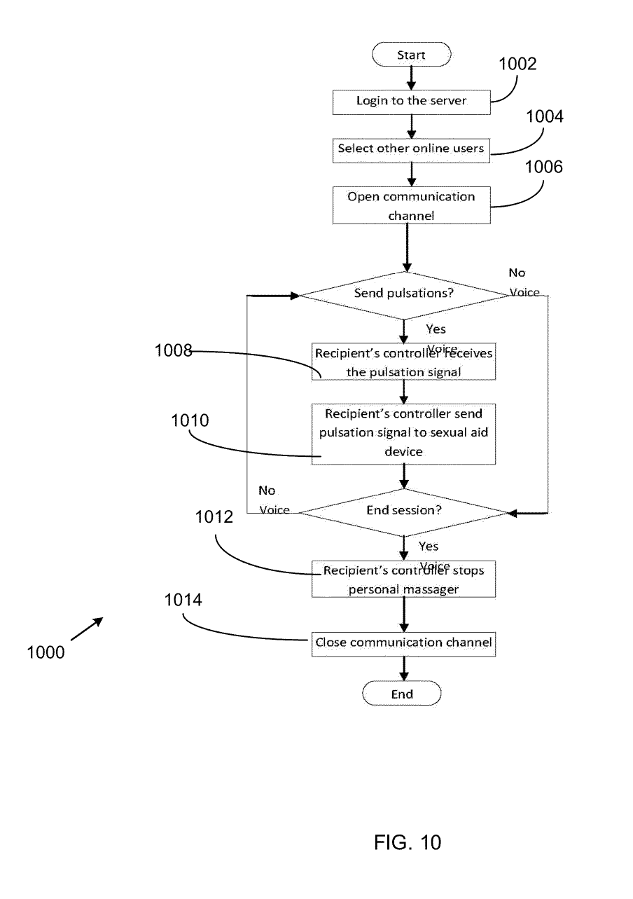

FIG. 10 illustrates a flowchart diagram of the steps for an exemplary remote pulsating method, in accordance with an embodiment of the present invention. In the present invention, a remote pulsating method 1000 may allow a user to playback a pulsation pattern that is received from a remote user. In non-remote application, the pulsation pattern may be retrieved from data stored in a computer readable media. In an initial Step 1002, the user may log into the server. It is noted that in the present embodiment, during long distance remote control, the audiovisual story is not needed, and the communications are pure texting. The sending of an image or audio is just a separate part of the communications.

In other embodiments, the pulsation pattern or an audiovisual story may be downloaded from the server or generated by the remote user with audio signals and images. Those skilled in the art, in light of the present teachings, will recognize that playing the audiovisual story may automate a pulsation device. A Step 1004 may allow a user to select other users, including the remote user to participate in the system. In some embodiments, a Step 1006 opens communication channels between each user, or the user and a remote storage device. A Step 1008 may include a user communication device receiving signals from a remote communication device. In some embodiments, a Step 1010 may include the remote communication device transmitting signals. In some embodiments, a Step 1012 may include the remote user terminating the signals, whereby the pulsation device may also terminate generating pulsation patterns. A final Step 1014 may include closing the communication channel between users.

In one alternative embodiment, a desktop or laptop application may transmit custom pulsation signals to the pulsation device automatically. The desktop or laptop application may be able to play the audiovisual story and send the associated custom pulsation signals to the pulsation device wirelessly. In yet another alternative embodiment, the communication device application may be re-programmed and used to connect to a body massager. Once connected, the communication device may serve as a remote controller that generates custom massaging styles to automate the body massager. In yet another alternative embodiment, a wireless module built into the pulsation device may be implemented into other types of personal massagers. In this manner, a communication channel may open from the personal massagers to the pulsation device. Any other personal massagers that are implemented with the wireless module may communicate similarly with the communication device.

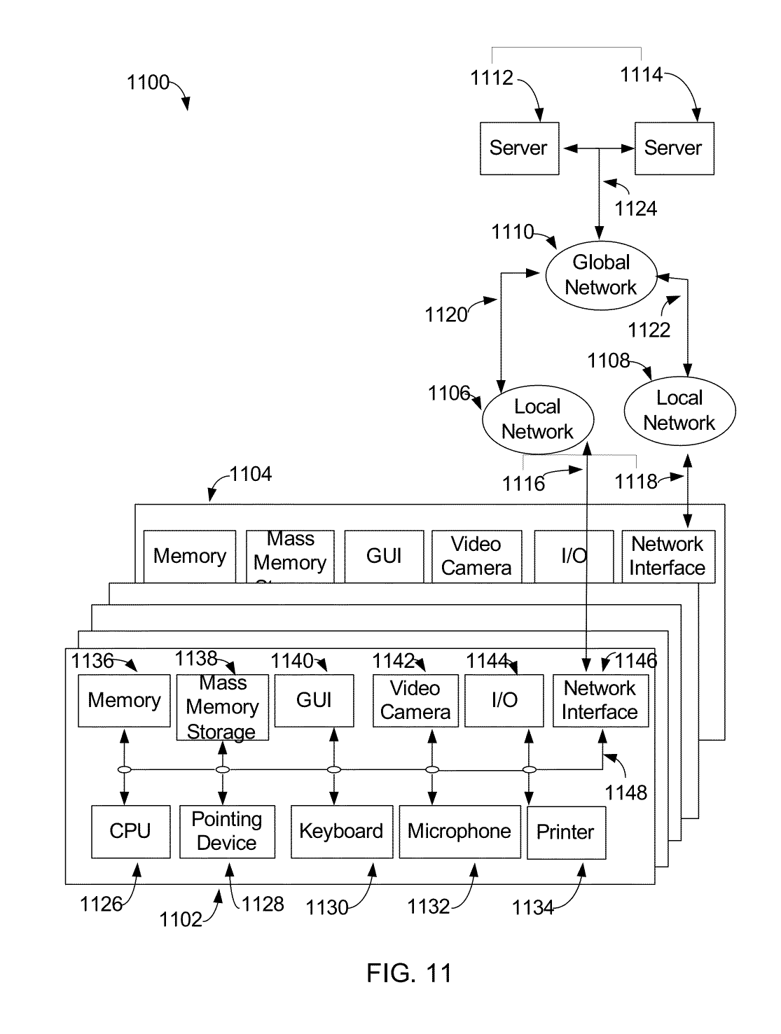

FIG. 11 illustrates a typical computer system that, when appropriately configured or designed, can serve as an exemplary method for tracking, in accordance with an embodiment of the present invention. In the present invention, a pulsating system may 1100 include a multiplicity of clients with a sampling of clients denoted as a client 1102 and a client 1104, a multiplicity of local networks with a sampling of networks denoted as a local network 1106 and a local network 11011, a global network 1110 and a multiplicity of servers with a sampling of servers denoted as a server 1112 and a server 1114.

Client 1102 may communicate bi-directionally with local network 1106 via a communication channel 1116. Client 1104 may communicate bi-directionally with local network 11011 via a communication channel 11111. Local network 1106 may communicate bi-directionally with global network 1110 via a communication channel 1120. Local network 11011 may communicate bi-directionally with global network 1110 via a communication channel 1122. Global network 1110 may communicate bi-directionally with server 1112 and server 1114 via a communication channel 1124. Server 1112 and server 1114 may communicate bi-directionally with each other via communication channel 1124. Furthermore, clients 1102, 1104, local networks 1106, 11011, global network 1110 and servers 1112, 1114 may each communicate bi-directionally with each other.

In one embodiment, global network 1110 may operate as the Internet. It will be understood by those skilled in the art that communication system 1100 may take many different forms. Non-limiting examples of forms for communication system 1100 include local area networks (LANs), wide area networks (WANs), wired telephone networks, wireless networks, or any other network supporting data communication between respective entities.

Clients 1102 and 1104 may take many different forms. Non-limiting examples of clients 1102 and 1104 include personal computers, personal digital assistants (PDAs), cellular phones and smartphones.

Client 1102 includes a CPU 1126, a pointing device 11211, a keyboard 1130, a microphone 1132, a printer 1134, a memory 1136, a mass memory storage 11311, a GUI 1140, a video camera 1142, an input/output interface 1144 and a network interface 1146.

CPU 1126, pointing device 11211, keyboard 1130, microphone 1132, printer 1134, memory 1136, mass memory storage 11311, GUI 1140, video camera 1142, input/output interface 1144 and network interface 1146 may communicate in a unidirectional manner or a bi-directional manner with each other via a communication channel 11411. Communication channel 11411 may be configured as a single communication channel or a multiplicity of communication channels.

CPU 1126 may be comprised of a single processor or multiple processors. CPU 1126 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 1136 is used typically to transfer data and instructions to CPU 1126 in a bi-directional manner. Memory 1136, as discussed previously, may include any suitable computer-readable media, intended for data storage, such as those described above excluding any wired or wireless transmissions unless specifically noted. Mass memory storage 11311 may also be coupled bi-directionally to CPU 1126 and provides additional data storage capacity and may include any of the computer-readable media described above. Mass memory storage 11311 may be used to store programs, data and the like and is typically a secondary storage medium such as a hard disk. It will be appreciated that the information retained within mass memory storage 11311, may, in appropriate cases, be incorporated in standard fashion as part of memory 1136 as virtual memory.

CPU 1126 may be coupled to GUI 1140. GUI 1140 enables a user to view the operation of computer operating system and software. CPU 1126 may be coupled to pointing device 11211. Non-limiting examples of pointing device 11211 include computer mouse, trackball and touchpad. Pointing device 11211 enables a user with the capability to maneuver a computer cursor about the viewing area of GUI 1140 and select areas or features in the viewing area of GUI 1140. CPU 1126 may be coupled to keyboard 1130. Keyboard 1130 enables a user with the capability to input alphanumeric textual information to CPU 1126. CPU 1126 may be coupled to microphone 1132. Microphone 1132 enables audio produced by a user to be recorded, processed and communicated by CPU 1126. CPU 1126 may be connected to printer 1134. Printer 1134 enables a user with the capability to print information to a sheet of paper. CPU 1126 may be connected to video camera 1142. Video camera 1142 enables video produced or captured by user to be recorded, processed and communicated by CPU 1126.

CPU 1126 may also be coupled to input/output interface 1144 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1126 optionally may be coupled to network interface 1146 which enables communication with an external device such as a database or a computer or telecommunications or internet network using an external connection shown generally as communication channel 1116, which may be implemented as a hardwired or wireless communications link using suitable conventional technologies. With such a connection, CPU 1126 might receive information from the network, or might output information to a network in the course of performing the method steps described in the teachings of the present invention.

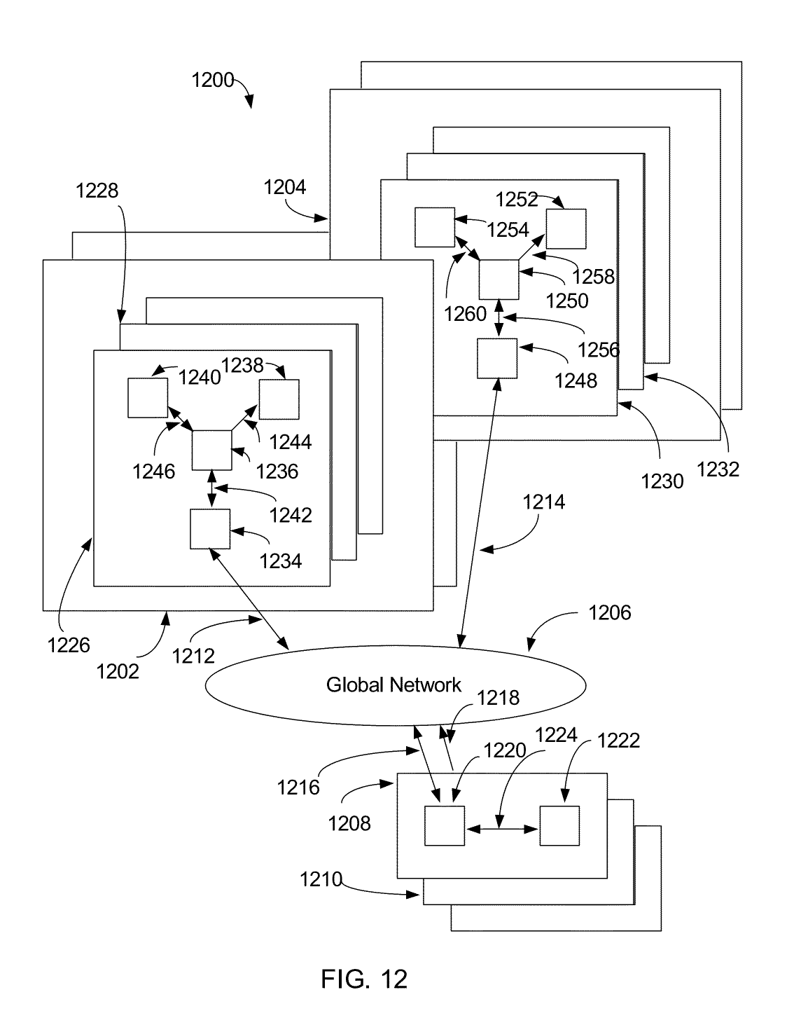

FIG. 12 illustrates a block diagram depicting a conventional client/server communication system, in accordance with an embodiment of the present invention. In the present invention, a communication system 1200 includes a multiplicity of networked regions with a sampling of regions denoted as a network region 1202 and a network region 1204, a global network 1206 and a multiplicity of servers with a sampling of servers denoted as a server device 1208 and a server device 1210.

Network region 1202 and network region 1204 may operate to represent a network contained within a geographical area or region. Non-limiting examples of representations for the geographical areas for the networked regions may include postal zip codes, telephone area codes, states, counties, cities and countries. Elements within network region 1202 and 1204 may operate to communicate with external elements within other networked regions or within elements contained within the same network region.

In some implementations, global network 1206 may operate as the Internet. It will be understood by those skilled in the art that communication system 1200 may take many different forms. Non-limiting examples of forms for communication system 1200 include local area networks (LANs), wide area networks (WANs), wired telephone networks, cellular telephone networks or any other network supporting data communication between respective entities via hardwired or wireless communication networks. Global network 1206 may operate to transfer information between the various networked elements.

Server device 1208 and server device 1210 may operate to execute software instructions, store information, support database operations and communicate with other networked elements. Non-limiting examples of software and scripting languages which may be executed on server device 1208 and server device 1210 include C, C++, C# and Java.

Network region 1202 may operate to communicate bi-directionally with global network 1206 via a communication channel 1212. Network region 1204 may operate to communicate bi-directionally with global network 1206 via a communication channel 1214. Server device 1208 may operate to communicate bi-directionally with global network 1206 via a communication channel 1216. Server device 1210 may operate to communicate bi-directionally with global network 1206 via a communication channel 1218. Network region 1202 and 1204, global network 1206 and server devices 1208 and 1210 may operate to communicate with each other and with every other networked device located within communication system 1200.

Server device 1208 includes a networking device 1220 and a server 1222. Networking device 1220 may operate to communicate bi-directionally with global network 1206 via communication channel 1216 and with server 1222 via a communication channel 1224. Server 1222 may operate to execute software instructions and store information.

Network region 1202 includes a multiplicity of clients with a sampling denoted as a client 1226 and a client 1228. Client 1226 includes a networking device 1234, a processor 1236, a GUI 1238 and an interface device 1240. Non-limiting examples of devices for GUI 1238 include monitors, televisions, cellular telephones, smartphones and PDAs (Personal Digital Assistants). Non-limiting examples of interface device 1240 include pointing device, mouse, trackball, scanner and printer. Networking device 1234 may communicate bi-directionally with global network 1206 via communication channel 1212 and with processor 1236 via a communication channel 1242. GUI 1238 may receive information from processor 1236 via a communication channel 1244 for presentation to a user for viewing. Interface device 1240 may operate to send control information to processor 1236 and to receive information from processor 1236 via a communication channel 1246. Network region 1204 includes a multiplicity of clients with a sampling denoted as a client 1230 and a client 1232. Client 1230 includes a networking device 1248, a processor 1250, a GUI 1252 and an interface device 1254. Non-limiting examples of devices for GUI 1238 include monitors, televisions, cellular telephones, smartphones and PDAs (Personal Digital Assistants). Non-limiting examples of interface device 1240 include pointing devices, mousse, trackballs, scanners and printers. Networking device 1248 may communicate bi-directionally with global network 1206 via communication channel 1214 and with processor 1250 via a communication channel 1256. GUI 1252 may receive information from processor 1250 via a communication channel 1258 for presentation to a user for viewing. Interface device 1254 may operate to send control information to processor 1250 and to receive information from processor 1250 via a communication channel 1260.

For example, consider the case where a user interfacing with client 1226 may want to execute a networked application. A user may enter the IP (Internet Protocol) address for the networked application using interface device 1240. The IP address information may be communicated to processor 1236 via communication channel 1246. Processor 1236 may then communicate the IP address information to networking device 1234 via communication channel 1242. Networking device 1234 may then communicate the IP address information to global network 1206 via communication channel 1212. Global network 1206 may then communicate the IP address information to networking device 1220 of server device 1208 via communication channel 1216. Networking device 1220 may then communicate the IP address information to server 1222 via communication channel 1224. Server 1222 may receive the IP address information and after processing the IP address information may communicate return information to networking device 1220 via communication channel 1224. Networking device 1220 may communicate the return information to global network 1206 via communication channel 1216. Global network 1206 may communicate the return information to networking device 1234 via communication channel 1212. Networking device 1234 may communicate the return information to processor 1236 via communication channel 1242. Processor 12126 may communicate the return information to GUI 1228 via communication channel 1244. User may then view the return information on GUI 1238.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing a pulsating system and method that controls a pulsating device with varying and preprogrammed signals from a remote area according to the present invention will be apparent to those skilled in the art. Various aspects of the invention have been described above by way of illustration, and the specific embodiments disclosed are not intended to limit the invention to the particular forms disclosed. The particular implementation of the pulsating system and method that controls a pulsating device with varying and preprogrammed signals from a remote area may vary depending upon the particular context or application. By way of example, and not limitation, the pulsating system and method that controls a pulsating device with varying and preprogrammed signals from a remote area described in the foregoing were principally directed to a sexual toy that vibrates in response to changes in a voice from a remote area or preprogrammed; however, similar techniques may instead be applied to a warehouse distribution system where robots access and photograph purchased items prior to shipping, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. One or more computer storage media storing computer-usable instructions, that when used by one or more computing devices, cause the one or more computing devices to perform a method comprising the steps of:
(a) connecting a pulsation device to a communication device;
(b) transmitting a signal from said communication device to said pulsation device;
(c) varying said signal; and
(d) pulsating said pulsation device in response to said signal.

2. The method of claim 1, in which said pulsation device comprises a sexual toy.

3. The method of claim 2, in which said pulsation device comprises a built-in Bluetooth module.

4. The method of claim 1, in which said communication device comprises a mobile device.

5. The method of claim 4, in which said varying of said signal is at least in part a modulation factor derived from an audio and/or visual signal.

6. The method of claim 1, in which step (b) further comprises a wireless connectivity.

7. The method of claim 6, in which said wireless connectivity comprises a radio frequency.

8. The method of claim 1, in which step (b) comprises a remote user transmitting said signal to a user.

9. The method of claim 8, in which said signal comprises a pulsation signal.

10. The method of claim 1, in which step (c) comprises varying pulsation signal with different intensity and duration.

11. The method of claim 1, wherein step (c) is operable to synchronize said signal with said pulsating device.

12. The method of claim 1, wherein step (c) is coordinates list of pulsation signals in chronological pattern.

13. The method of claim 1, in which step (d) comprises vibrating said pulsation device.

14. The method of claim 1, in which step (d) comprises synchronizing a pulsation pattern with an audio visual story.

15. The method of claim 1, in which a preprogrammed signal comprises an audiovisual story.

16. The method of claim 15, in which said audiovisual story comprises one of more of these music, a voice, video, and an image.

17. The method of claim 16, wherein said audiovisual story is operable to save in a communication device storage and/or a remote storage device.

18. The method of claim 8, wherein said user may retrieve said audiovisual story from a communication device storage and/or a remote storage device.

19. The method of claim 18, in which said remote storage device comprises a server.

20. A system for pulsations comprising:
means for connecting a pulsation device to a communication device;
means for transmitting a signal from said communication device to said pulsation device;
means for varying said signal; and
means for pulsating said pulsation device in response to said signal.

21. A non-transitory program storage device readable by a machine tangibly embodying a program of instructions executable by the machine to perform a method for generating pulsations comprising:
(a) computer code for connecting a pulsation device to a communication device;
(b) computer code for creating a pre-programmed pattern of pulsation behaviors suitable for execute on a pulsation device, which creation is not based on any audio and/or visual input signal;
(c) computer code for transmitting a signal from said communication device to said pulsation device, said signals comprising said pre-programmed pattern of pulsation behaviors; and
(d) computer code for pulsating said pulsation device in response to said signal at least in part according to said pre-programmed pattern of pulsation behaviors.
